(19) United States
(12) Patent Application Publication
(10) Pub. No.: US 2021/0323407 A1
(43) Pub. Date: Oct. 21, 2021

(54) VEHICLE INTEGRATED SAFETY SYSTEM GENERATING MAP POINTS AND AUDIBLE, VISUAL WARNING

(71) Applicant: Demetrius Thompson, Beverly Hills, CA (US)

(72) Inventor: Demetrius Thompson, Beverly Hills, CA (US)

(21) Appl. No.: 17/228,352

(22) Filed: Apr. 12, 2021

Related U.S. Application Data
(60) Provisional application No. 63/010,883, filed on Apr. 16, 2020.

(51) Int. Cl. B60K 35/00; B60Q 9/00

(52) U.S. Cl. CPC B60K 35/00; B60Q 9/008; B60K 2370/178; B60K 2370/589; B60K 2370/164; B60K 2370/119; B60K 2370/179

(57) ABSTRACT

A warning system installed directly in a vehicle's infotainment system, comprising a wireless communication device, a component detecting whether a condition of the vehicle's is such as to turn on the wireless communication device, and software integrated into the vehicle's infotainment system that determines if the vehicle is approaching a hazard or potential hazard, and a component that issues a warning if the foregoing determinations are positive. A method is also provided for detecting whether a condition of the vehicle's is such as to turn on the wireless communication device. The method determines if the vehicle is approaching a hazard or potential hazard and issues a warning if the foregoing determinations are positive.

### BENEFIT

This application claims the benefit of provisional patent application No. 63/010,883 filed Apr. 16, 2020.

### FIELD OF THE INVENTION

The invention relates to a vehicle integrated system for generating map points and audible, visual warnings in a vehicle.

### BACKGROUND OF THE INVENTION

Talking on a phone while driving, whether with a hand-held phone or using an in-dash phone, is a major and dangerous distraction, to the point that a number of states have passed laws making it a misdemeanor to use a hand-held phone while driving. Significant solutions can be found in the technology developed by the current inventor, Demetrius Thompson of Global Mobile Alert Corporation in U.S. Pat. Nos. 7,308,247 and 7,986,934, each titled “Cellular Telephone Safety System,” and U.S. Pat. No. 9,568,334 titled “Safe Driving System Generating Map Points”. The teachings of U.S. Pat. Nos. 7,308,247; 7,986,934; and 9,568,334, and the references cited therein are incorporated by reference herein. Collectively, these patents describe software that increase driver safety by generating a warning when it detects when a potential hazard is near while a wireless communication device is in active voice mode (hereinafter “Safety Software”). The Safety Software can warn when a traffic light is red or is calculated to be red by the time the vehicle reaches the intersection. It can also be used to generate a warning when the vehicle is approaching other potential hazards such as a school zone or a railway crossing. The Safety Software can generate an audible alarm as the warning. Vehicle GPS navigation systems, sometimes called infotainment systems, and mobile GPS navigation systems, display the location of the user on a map generated by the system. Such systems are capable of displaying icons showing locations on the map of various points of interest chosen by the user, such as ATMs, restaurants, fire stations, police stations, emergency rooms, and the like. In addition to an audible warning, the Safety Software can generate an icon of the hazard on the screen of an infotainment system.

Up until this invention, such warnings were provided with an app containing the Safety Software. Such an app is Global Mobile Alert which can be downloaded from various locations such as Apple's App store (for iOS platforms) and Google Play (for Android platforms). The app containing the Safety Software is loaded directly onto the mobile phone, the same device on which the Safety Software generates the potential hazard warning. However, if the driver is speaking on a mobile phone that does not have the Safety Software installed or turned on, no warning is given.

### BRIEF SUMMARY OF THE INVENTION

A warning system installed directly in and integrated with a vehicle's infotainment system, comprising a wireless communication device, a component detecting whether a condition of the vehicle's is such as to turn on the wireless communication device. Safety Software integrated into the vehicle's infotainment system determines if the vehicle is approaching a hazard or potential hazard and has a component that issues a warning if the foregoing determinations are positive. A method is thus provided for detecting whether a condition of the vehicle is such as to turn on the wireless communication device. The method determines if the vehicle is approaching a hazard or potential hazard and issues a warning if the foregoing determinations are positive.

### BRIEF DESCRIPTION OF THE DRAWINGS

FIG. 1 is a flowchart illustrating operation of the method; and

FIG. 2 is a depiction of the infotainment screen in a car with a navigation system installed and depicts a warning icon of a traffic light.

### DETAILED DESCRIPTION OF THE INVENTION

The present invention provides Safety Software installed directly into a vehicle's infotainment system, which can run in the background after the Safety Software is closed. The infotainment system incorporates several functions including detecting the initial powering up of the vehicle's electrical system. This can start when a key-fob is in close proximity to the vehicle, when the driver side door opens or when the vehicle is started. The Safety Software is fully integrated into the vehicle's infotainment center and will cross reference the acceleration, GPS positioning, and the vehicles speed profile to determine when a visual and audible alert warning is necessary to increase awareness to a distracted driver.

The first action that takes place is the Safety Software's interaction with the vehicle's infotainment center to determine when the electric power supply is provided to initiate the Safety Software. A decision point is when a driver shifts the vehicle's gear system from park or neutral to drive or forward gears. Once this action takes place, the Safety Software will engage and start in the infotainment system's background. The Safety Software will then interface with the vehicle's computer to ensure that it is interfacing with the vehicle's acceleration sensors, GPS positioning system and the vehicle's speedometer data system. Once the Safety Software is interfacing with the vehicle systems, it will determine if a wireless communication device, such as a mobile phone, is on an active phone call. An active call is when someone is talking or listening on the phone. The wireless communication device can be a hand held device such as a smartphone or a mobile phone in communication with the vehicle's infotainment system either by Bluetooth or directly connected, the word “wireless” signifying only that the device or Safety Software obtains location information wirelessly, including GPS, road side generated information that can be picked up by the device or infotainment system, or signals generated by a traffic light, or from other vehicles in communication with the device or infotainment system.

If the wireless communication device is on an active call, then the Safety Software will calculate the potential safety sensitive points of interest (POI's) such as traffic lights, school zones and railroad crossings and determine the necessary time that an audible and visual alarm warning should be initiated. This would be accomplished by determining if the traffic light is a yellow light or a red light or is calculated to be yellow or red by the time the vehicle reaches the traffic light, displaying the visual icon only if the determination is positive for an active call.

Since the Safety Software is integrated into the vehicle's infotainment system, the Safety Software would be able to send a signal to engage any other warning systems in the vehicle at the same time it provides an audible alarm.

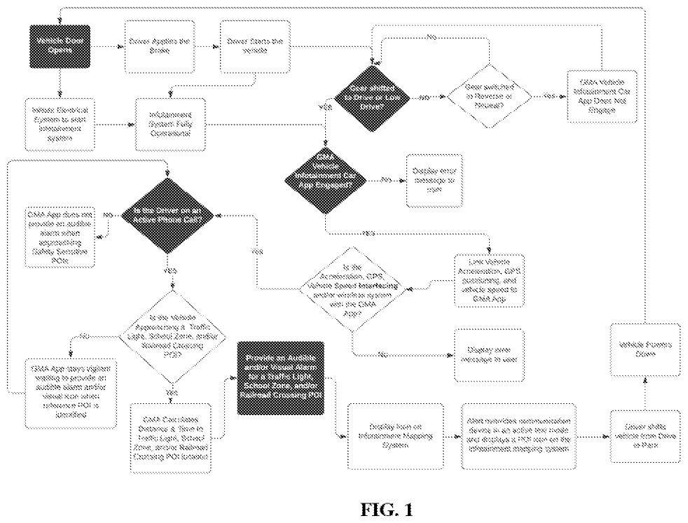

FIG. 1 is a flow chart for one embodiment of the invention. As shown in the flow chart, in this embodiment the Safety Software will not engage unless the vehicle door opens, the driver applies the brakes, or the driver starts the vehicle. If the driver shifts to drive or low drive but the gear is switched to reverse or neutral, the Safety Software does not engage. Otherwise the electrical system starts the infotainment system making it fully operational and the Safety Software is engaged to determine the current location of the vehicle, determine the GPS location of a hazard or potential hazard, determine if the location of the hazard or potential hazard is within a predetermined distance from the hazard or potential hazard, and determines if the wireless communication device is in an active voice mode. If the foregoing is positive then an audio alert is issued and a display of an icon of a hazard or potential hazard is displayed. The audio alert can be any sound that can be heard such as a ping sound, a ringing sound, a voice generated by the system, e.g., “traffic light approaching,” or the like.

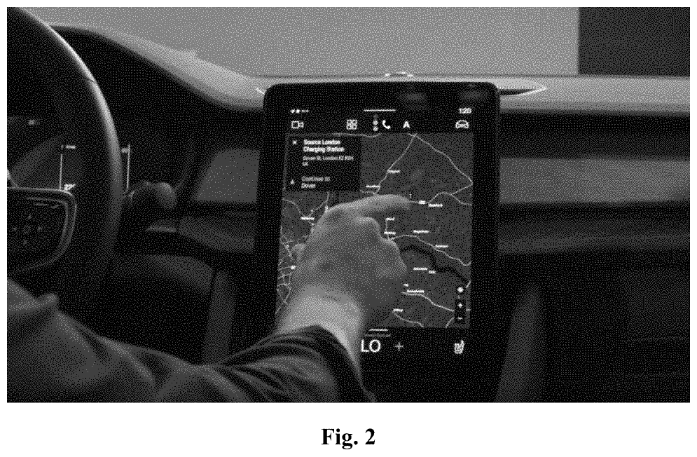

FIG. 2 shows a vehicle infotainment system with an icon of a traffic signal displayed as a result of the integrated system detecting that the vehicle is approaching a traffic light while the wireless communication device on an active phone call.

1. A warning system installed directly in a vehicle's infotainment system, comprising:
a wireless communication device;
a component detecting whether a condition of the vehicle's is such as to turn on the wireless communication device;
software integrated into the vehicle's infotainment system that determines the current location of the vehicle, determines the GPS location of a hazard or potential hazard, determines if the location of the hazard or potential hazard is within a predetermined distance from the hazard or potential hazard, and determines if the wireless communication device is in an active voice mode; and
a component that issues a warning if the foregoing determinations are positive.

2. The warning system of claim 1 wherein the warning is an audio alert and/or is a display of an icon representing the hazard or potential hazard.

3. The warning system of claim 1 wherein the component detecting whether a condition of the vehicle's is such as to turn on the wireless communication device detects when a key-fob is in close proximity to the vehicle, or when the driver side door opens, or when the vehicle is started or when a driver shifts the vehicle's gear system from park or neutral to drive or forward gears.

4. The warning system of claim 1 wherein a component of the software determines that the software is interfacing with the vehicle's GPS positioning system and the vehicle's speedometer data system and determines if the driver is on an active phone call.

5. A method for improving safety for use with an infotainment system integrated with a wireless communication device and a warning system installed directly in a vehicle's infotainment system, comprising:
detecting whether a condition of the vehicle's is such as to turn on the wireless communication device;
determining the current location of the vehicle;
determining the GPS location of a hazard or potential hazard;
determining if the location of the hazard or potential hazard is within a predetermined distance from the hazard or potential hazard;
determining if the wireless communication device is in an active voice mode; and
issuing a warning if the foregoing determinations are positive.

6. The method of claim 5 wherein the warning is an audio alert and/or is a display of an icon representing the hazard or potential hazard.

7. The method of claim 5 wherein detecting whether a condition of the vehicle's is such as to turn on the wireless communication device comprises detecting when a key-fob is in close proximity to the vehicle, or when the driver side door opens, or when the vehicle is started or when a driver shifts the vehicle's gear system from park or neutral to drive or forward gears.

8. The method of claim 5 comprising determining that the wireless communication device is interfacing with the vehicle's GPS positioning system and the vehicle's speedometer data system.

9. The method of claim 2 wherein the warning comprises a voice generated by the system.

10. The method of claim 6 wherein the warning comprises a voice generated by the system.
